(19) United States
(12) Patent Application Publication
(10) Pub. No.: US 2025/0033701 A1
(43) Pub. Date: Jan. 30, 2025

(54) ECCENTRIC LOCKING PIN

(71) Applicant: SAF-Holland, Inc., Muskegon, MI (US)

(72) Inventor: Jeffrey M. Galla, Norton Shores, MI (US)

(21) Appl. No.: 18/917,263

(22) Filed: Oct. 16, 2024

Related U.S. Application Data
(60) Provisional application No. 63/601,478, filed on Nov. 21, 2023.

(51) Int. Cl. B62D 21/14; B62D 53/06; B62D 63/06; B62D 63/08

(52) U.S. Cl. CPC B62D 21/14; B62D 53/06; B62D 63/061; B62D 63/08

(57) ABSTRACT

A locking pin for a trailer having a trailer frame assembly and a slide box configured to be supported by a suspension arrangement and slidably displaceable along the trailer frame assembly, including a pin body having a first end configured to couple to an actuator and a second end, and a pin end extending from the second end of the pin body and including a first portion having a substantially circular cross-section and configured to be received within a corresponding aperture in the slide box of the trailer and a second portion having a substantially circular cross-section configured to be selectively received within a corresponding aperture in the trailer frame assembly to prevent the slide box from sliding with reference to the trailer frame assembly where the second portion is linearly offset from the first portion.

### CROSS-REFERENCE TO RELATED APPLICATIONS

This application claims benefit to U.S. Provisional Patent Application No. 63/0601,478, entitled “ECCENTRIC LOCKING PIN,” filed Nov. 21, 2023, the entire disclosure of which is incorporated herein by reference.

### BACKGROUND OF THE INVENTION

The embodiments as shown and described relate to a locking pin, particularly for heavy duty towed vehicles, and particularly a locking pin for a vehicle suspension arrangement that allows sliding repositioning of a supporting suspension assembly with respect to an associated vehicle frame assembly.

### BRIEF SUMMARY OF THE INVENTION

One embodiment as described and shown herein includes a locking pin for a trailer having a trailer frame assembly and a slide box configured to be supported by a suspension arrangement and slidably displaceable along the trailer frame assembly, the locking pin including a pin body having a first end configured to couple to an actuator and a second end, and a pin end extending from the second end of the pin body. The pin end includes a first portion having a substantially circular cross-section and configured to be received within a corresponding aperture in the slide box of the trailer and a second portion having a substantially circular cross-section configured to be selectively received within a corresponding aperture in the trailer frame assembly to prevent the slide box from sliding with reference to the trailer frame assembly. The second portion is linearly offset from the first portion.

Another embodiment as shown and described herein may further or alternatively include a vehicle control arrangement that may include a locking pin for a slide box of a towed vehicle, the slide box configured to be supported by a suspension assembly and configured to be slidably displaced along a length of a vehicle frame assembly, the locking pin including a pin body having a first end configured to couple to an actuator, a second end, and a first center axis extending along a length of the locking pin, and a pin end extending from the second end of the pin body. The pin end includes a substantially cylindrical first portion having a first diameter, and a substantially cylindrical second portion having a second diameter. The first portion extends along the first center axis, and the second portion extends along a second center axis laterally offset from the first center axis. The second diameter is smaller than the first diameter. The second portion is configured to engage the vehicle frame assembly thereby preventing the sliding displacement of the slide box along the length of the vehicle frame assembly.

Yet another embodiment as shown and described herein includes a method for controlling a vehicle suspension that may include providing a towed vehicle that include, a vehicle frame assembly including a pair of frame rails each defining a plurality of pin apertures spaced along a length of each of the pair of frame rails, where each pin aperture of the plurality of pin apertures has a first diameter. A slide box including a pair of slide rails configured to slide within the pair of frame rails, where one of the slide rails of the pair of slide rails defines a slide box aperture having a second diameter, and wherein the second diameter is larger than the first diameter. An eccentric locking pin includes a pin body and a pin end, the pin body having a first center axis extending along a length of the eccentric locking pin and including a proximal end and a distal end, the pin end coupled to the distal end of the pin body and including a first portion aligned with the first center axis, and a second portion aligned with a second center axis laterally offset from the first center axis. An actuator coupled to the proximal end of the pin body and configured to move the eccentric locking pin between an unlocked position allowing the slide box to slide along the frame rails and a locked position preventing the slide box from sliding along the frame rails. The second portion of the pin end is received within a pin aperture of the plurality of pin apertures in the locked position, and where the first portion of the pin end is at least partially received within the slide box in the locked position and the unlocked position.

These and other features, advantages, and objects of the embodiments as disclosed herein will be further understood and appreciated by those skilled in the art by reference to the following specification, claims, and appended drawings.

### BRIEF DESCRIPTION OF THE DRAWINGS

FIG. 1 is a side perspective view of an eccentric locking pin for a towed vehicle, where the eccentric locking pin includes a pin body and a pin end;

FIG. 2 is an end elevational view of a pin end of the eccentric locking pin;

FIG. 3 is a side elevational view of a vehicle arrangement including a towing vehicle, such as a semi-truck, and a towed vehicle, such as a semi-trailer, where the towed vehicle includes a trailer frame assembly and a slide box;

FIG. 4 is a perspective view of the slide box and a portion of a vehicle frame assembly for the towed vehicle, where the slide box includes a locking arrangement;

FIG. 5 is a side elevational view of a portion of the slide box with a pin aperture and the vehicle frame assembly with a frame locking aperture, where the pin aperture is not aligned with the frame locking aperture;

FIG. 6 is a side elevational view of a portion of the slide box with the pin aperture and the vehicle frame assembly with the frame locking aperture, where the pin aperture is aligned with the frame locking aperture;

FIG. 7 is a perspective view of the slide box with the pin aperture and the locking pin in an unlocked position;

FIG. 8 is a schematic cross-sectional view of the slide box with the pin aperture, the vehicle frame assembly with the frame locking aperture, and the locking pin in the unlocked position;

FIG. 9 is a perspective view of the slide box with the pin aperture and the locking pin in a locked position; and

FIG. 10 is a schematic cross-sectional view of the slide box with the pin aperture, the vehicle frame assembly with the frame locking aperture, and the locking pin in a locked position.

### DETAILED DESCRIPTION

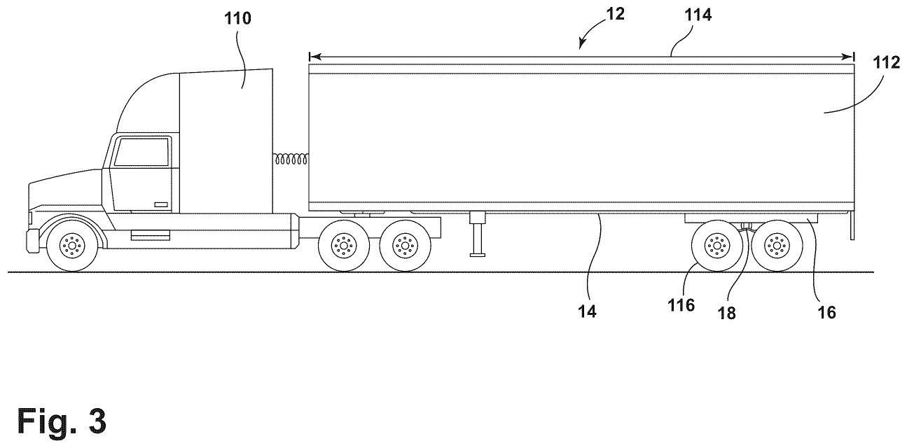

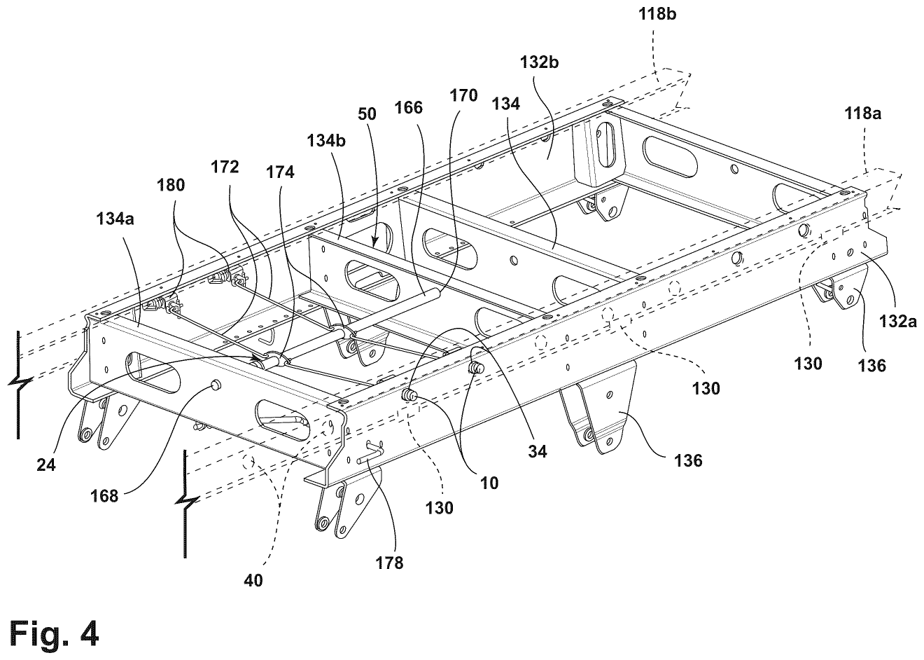

For purposes of description herein, the terms “upper,” “lower,” “right,” “left,” “rear,” “front,” “vertical,” “horizontal,” and derivatives thereof shall relate to the invention as oriented in FIGS. 3 and 4. However, it is to be understood that the embodiments as disclosed herein may assume various alternative orientations, except where expressly specified to the contrary. It is also to be understood that the specific devices and processes illustrated in the attached drawings, and described in the following specification are exemplary embodiments of the inventive concepts defined in the appended claims. Hence, specific dimensions and other characteristics relating to the embodiments disclosed herein are not to be considered as limiting, unless the claims expressly state otherwise.

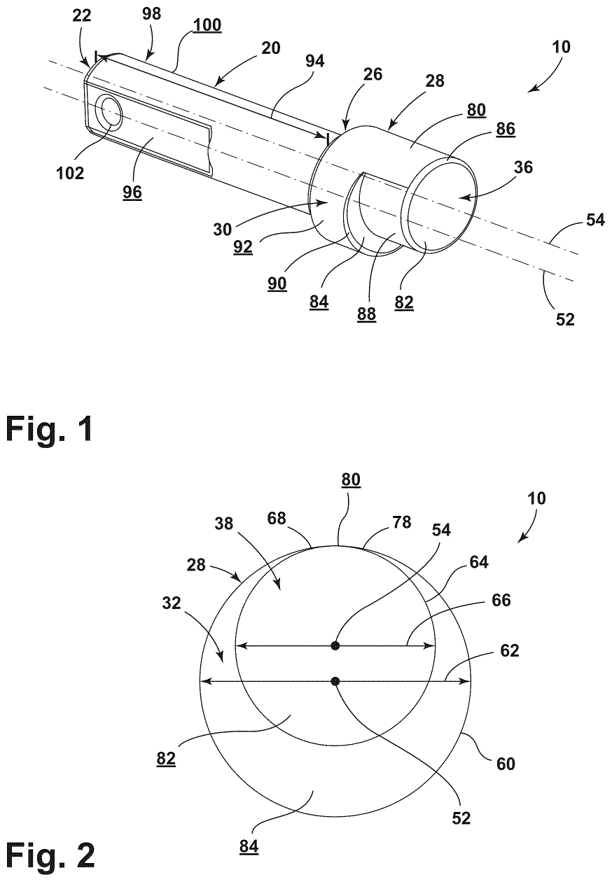

Referring to FIGS. 1-10, the reference numeral 10 generally designates a locking pin or an eccentric locking pin, which may be included in a plurality of locking pins 10, for a trailer or towed vehicle 12. The trailer 12 generally includes a trailer or vehicle frame assembly 14 and a slide box 16. The slide box 16 is configured to be supported by a suspension arrangement or assembly 18, and slidably displaceable along the trailer frame assembly 14. In the illustrated example, the locking pin 10 includes a pin body 20 having a first or proximal end 22, configured to couple to an actuator 24 and a second or distal end 26. A pin end 28 extends from the second end 26 of the pin body 20. The pin end 28 includes a first portion 30 having a substantially circular first cross-section 32, configured to be received within a corresponding aperture 34, which may be included in a plurality of pin apertures 34 or slide box apertures 34, defined by the slide box 16 of the trailer 12. The pin end 28 includes a second portion 36 having a substantially circular second cross-section 38, configured to be selectively received within a corresponding aperture 40, which may be included in a plurality of frame locking apertures 40, defined by the trailer frame assembly 14 to prevent the slide box 16 from sliding with reference to the trailer frame assembly 14. The second portion 36 is linearly offset from the first portion 30.

Referring to FIGS. 1 and 2, the locking pin 10 is included in a locking arrangement 50 for the trailer 12. The locking pin 10 is generally configured to prevent sliding of the slide box 16 relative to the trailer frame assembly 14 when engaged with one of the frame locking apertures 40. The locking pin 10 includes the pin body 20 with the first end 22 and the second end 26 and the pin end 28 having the first portion 30 and the second portion 36 extending from the second end 26 of the pin body 20. In the illustrated example, the pin body 20 and the pin end 28 are generally a continuous, single-piece of ridged material, such as steel, or other metals or metal alloys. However, it is contemplated that the pin body 20 and the pin end 28 may be separate components joined together using a mechanical fastener, such as a bolt, or welded together.

The locking pin 10 includes the pin body 20 and the first portion 30 of the pin end 28 extending along a first center axis 52 and the second portion 36 of the pin end 28 extending along a second center axis 54. The first center axis 52 aligns with a center point of a cross-section of the pin body 20 and a center point of the first cross-section 32 of the pin end 28. The first portion 30 of the pin end 28 has the first cross-section 32. The second center axis 54 aligns with a center point of the second cross-section 38 of the pin end 28. The second portion 36 of the pin end 28 has the second cross-section 38.

The first and second cross-sections 32, 38 of the pin end 28 may be substantially circular. A perimeter 60 of the first cross-section 32 has a first pin diameter 62, and a perimeter 64 of the second cross-section 36 has a second pin diameter 66. The second pin diameter 66 is generally smaller than the first pin diameter 62. In implementations with the substantially circular cross-sections 32, 38, the first portion 30 and the second portion 36 of the pin end 28 may be substantially cylindrical. Stated differently, the first portion 30 extending along the first center axis 52 may be a substantially cylindrical first portion of the pin end 28 and the second portion 36 extending along the second center axis 54 may be a substantially cylindrical second portion.

The first center axis 52 and the second center axis 54 are laterally offset and extend parallel to each other, i.e., the first center axis 52 and the second center axis 54 do not intersect and extend on the same plane. The first portion 30 of the pin end 28 is laterally offset from the second portion 36 of the pin end 28. In various implementations, the second portion 36 and the second center axis 54 may be vertically offset the first portion 30 and the first center axis 52.

Referring still to FIGS. 1 and 2, the first and second center axis 52, 54 of the locking pin 10 may be offset such that a portion 68 of the first cross-section 32 and a portion 70 of the second cross-section 38 are tangentially aligned. Along the tangentially aligned portions 68, 70 a flush surface 80 extends between the first portion 30 and the second portion 36 of the pin end 28. Stated differently, the portion 68 of the first cross-section 32 and the portion 70 of the second cross-section 38 portion are aligned to define the flush surface 80 extending between the first portion 30 and the second portion 36 of the pin end 28.

The pin end 28 includes an end surface 82 defined on the second portion 36 and a shoulder surface 84 defined on the first portion 30. The pin end 28 may also include a tapered end surface 86 extending from the end surface 82 to a side surface 88 of the second portion 36 and a tapered shoulder surface 90 extending from the shoulder surface 84 to a side surface 92 of the first portion 30. Accordingly, the first and second cross-sections 32, 38 of the pin end 28 may vary for each of the portions 30, 36 due to the tapered surfaces 86, 90. While the cross-sections 32, 38 may vary, the cross-sections 32, 38 are generally substantially similar for each portion 30, 36 of the pin end 28. The tapered surface 86, 90 may assist in engaging and disengaging the locking pin 10 with the pin apertures 34, as discussed herein. The side surfaces 88, 92 may be continuous with the portions of the flush surface 80 extending on the corresponding portions 30, 36.

The pin body 20 may have a single and continuous cross-section extending a length 94 of the pin body 20. For example, the pin body 20 may have a circular cross-section forming a cylindrical pin body 20. In other implementations, the pin body 20 may include multiple cross-sections extending the length 94 of the pin body 20. As illustrated in FIG. 1, the pin body 20 includes a first truncated surface or first flat surface 96, extending along a portion 98 of the length 94 of the pin body 20 and a second truncated surface or second flat surface 100, extending along the portion 98 the length 94 of the pin body 20. The second truncated surface 100 directly opposes the first truncated surface 96. The pin body 20 is substantially cylindrical extending from the first and second truncated surfaces 96, 100 to the second end 26. The second end 26 of the pin body 20 has a substantially circular cross-section having a diameter. The diameter of the second end 26 of the pin body 20 may less than the first diameter 62 of the pin end 28. It is contemplated that other cross-sectional profiles or other combinations of cross-section profiles may be used for the pin body 20.

The locking pin 10 may also include an aperture 102 defined through the pin body 20 to couple the locking pin 10 to the actuator 24. The aperture 102 is generally defined proximate the first end 22 of the pin body 20. As illustrated in FIG. 1, the aperture 102 extends between the first truncated surface 96 and the second truncated surface 100. The aperture 102 may be configured to receive a portion of the actuator 24 or a fastener configured to couple the actuator 24 to the locking pin 10.

Referring to FIGS. 3 and 4, the trailer 12 is generally configured to be coupled and towed by a tractor 110, which may be a semi-truck. The trailer 12 includes the trailer frame assembly 14 that supports an associated overall vehicle assembly 112 and extends at least part of a length 114 of the trailer 12. The associated overall vehicle assembly 112 is illustrated in FIG. 3 as a heavy duty, commercial trailer, but is not limited to such configuration. The trailer frame assembly 14 slidably engages the slide box 16. The suspension arrangement 18 includes axle members and is operably coupled to the slide box 16. The suspension arrangement 18 is supported by wheel assemblies 116 coupled to the axle members.

The trailer frame assembly 14 includes a pair of longitudinally-extending vehicle frame rails 118, which includes a first frame rail 118a and a second frame rail 118b. Each of the frame rails 118 may have a Z-shaped cross-sectional configuration, but may also be other cross-sectional configurations (e.g., C-shaped). Each of the frame rails 118 may define the plurality of frame locking apertures 40 extending along at least a portion of the length 114 of the trailer 12. The frame locking apertures 40 are configured to receive the second portion 36 of the pin end 28. Each of the frame apertures 40 have a center point 120 and a diameter 122. The diameter 122 of each of the frame apertures 40 may be substantially similar to the second pin diameter 66 of the pin end 28 and allow the second portion 36 of the pin end 28 to be received through the frame apertures 40. The diameter 122 of each of the frame apertures 40 may also be larger than the second pin diameter 66 of the pin end 28 by about 5%, or about 10% to allow for ease of engagement between the locking pin 10 and the frame locking apertures 40.

The frame locking apertures 40 may be evenly spaced along each of the frame rails 118. The center point 120 may be positioned such that the second center axis 54 of the locking pin 10 are aligned when the locking pin 10 is engaged with the frame locking aperture 40. The aperture center points 120 of each of the frame locking aperture 40 may be horizontally aligned along each of the frame rails 118. Stated differently, the center points 120 of each of the apertures 40 may be the same distance from a reference line or surface that extends the length 114 of the trailer 12 (e.g., a lower surface of the overall vehicle assembly 112). Each of the apertures 40 may align with a corresponding aperture 40 defined on the opposing frame rail 118. Accordingly, the center points 120 of each of the frame locking apertures 40 may separately be aligned and engaged with the locking pins 10.

Referring still to FIGS. 3 and 4, the slide box 16 is slidably coupled to the trailer frame assembly 14 and configured to be adjusted or displaced along at least a portion of the length 114 of the trailer 12. The slide box 16 may be coupled to the trailer frame assembly 14 via a plurality of slider brackets 130. The slider brackets 130 are generally coupled to a pair of slide rails 132 of the slide box 16 and each include a U-shaped section that extends about an outwardly-extending lower flange of the corresponding Z-shaped frame rails 118. The pair of slide rails 132 of the slide box 16 extend parallel to the pair of frame rails 118 when coupled thereto. A plurality of support members 134, which may include a first support member 134a and a second support member 134b, extend perpendicular between the pair of slide rails 132 to generally define the structure of the slide box 16. A variety of suspensions brackets 136 may be coupled to the slide rails 132 and/or support members 134 to couple the slide box 16 to the suspension arrangement 18.

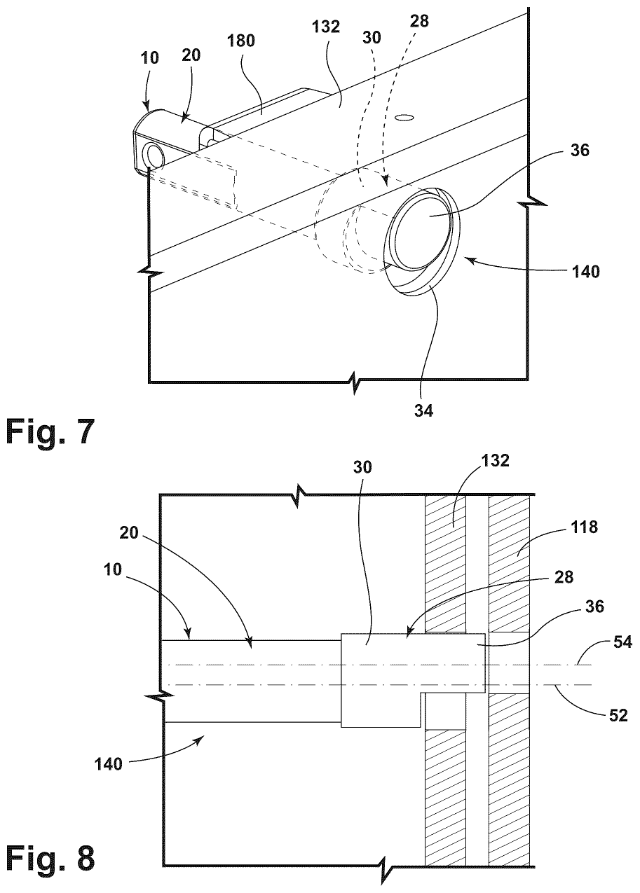

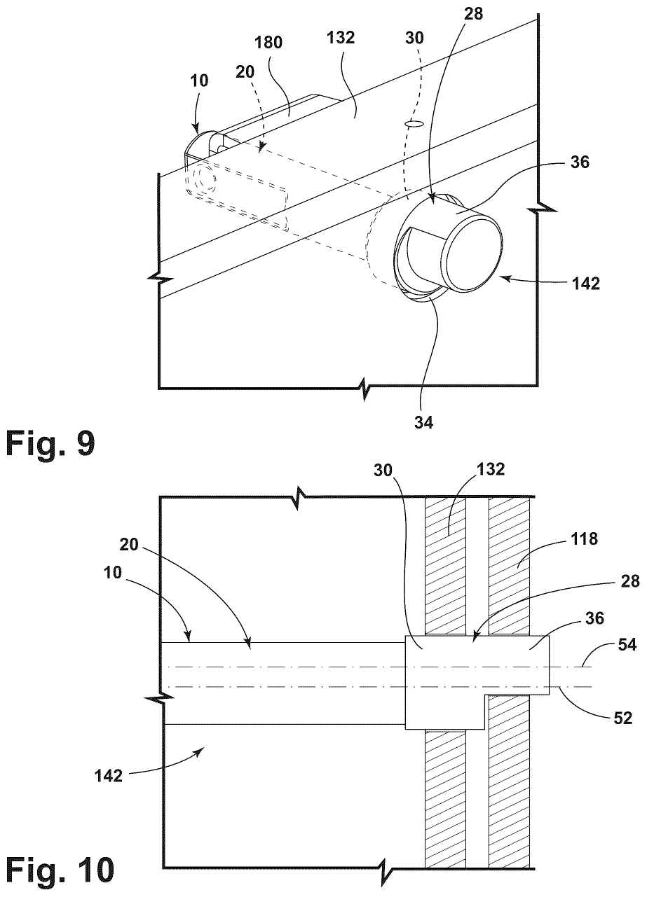

Referring to FIGS. 3, 4, and 5-10, the slide box 16 further includes the locking arrangement 50 that includes the actuator 24 and the locking pin 10. In various implementations, the locking arrangement 50 may include a plurality of locking pins 10 each coupled to the actuator 24 or a plurality of actuators 24. The actuators 24 are generally configured to move the locking pins 10 between an unlocked position 140 (FIGS. 7 and 8), allowing the slide box 16 to be moved relative to the trailer frame assembly 14, and a locked position 142 (FIGS. 9 and 10), preventing the slide box 16 from moving relative to the trailer frame assembly 14.

Referring to FIGS. 3-6, the slide box 16 includes the pin apertures 34 defined on at least one of the slide rails 132. The pin apertures 34 each have an outer diameter 144 and a center point 146. The diameter 144 of each of the pin apertures 34 may be substantially similar to the first diameter 62 of the pin end 28 and allow for the first portion 30 of the pin end 28 to extend through the pin apertures 34. The diameter 144 of each of the pin apertures 34 may also be larger than the first diameter 62 of the pin end 28 by about 5%, or about 10% to allow for ease of movement of the locking pin 10 through the pin apertures 34. In various implementations, each of the slide rails 132 will define a plurality of the pin apertures 34. Each of the pin apertures 34 may correspond to a locking pin 10. For example, the locking arrangement 50 may include four locking pins 10 each corresponding to a pin aperture 34, with two pin apertures 34 defined on each of the slide rails 132.

The center points 146 of each of the pin apertures 34 align with the first center axis 52 of the locking pin 10. The distance between the center points 146 of each of the pin apertures 34 on each of the slide rails 132 may be equal to the distance or a multiple of the distance between the center points 120 of the frame locking apertures 40. Additionally, the center points 146 of each of pin apertures 34 may horizontally aligned along each of the slide rails 132. Stated differently, the center points 146 of each of the apertures 34 may be the same distance from a reference line or surface that extends the length 114 of the trailer 12 (e.g., a lower surface of the overall vehicle assembly 112). The center points 146 of each of the pin apertures 34 may also align with the center point 146 of a pin aperture 34 on the opposing slide rail 112. This allows for each of the corresponding locking pins 10 to be aligned with one of the frame locking apertures 40.

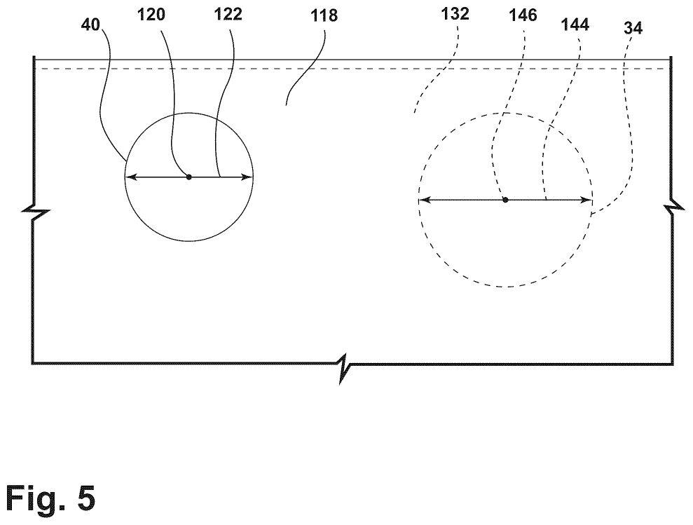

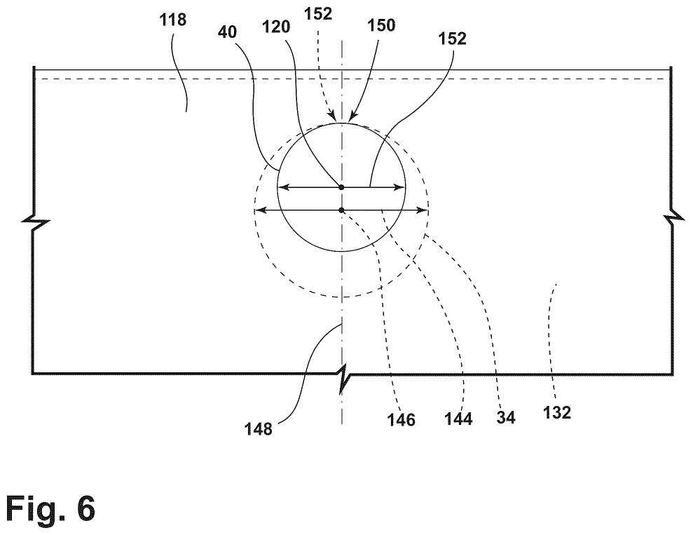

When the locking pins 10 are in the unlocked position 140, the slide box 16 may be moved along the partial length 114 of the trailer 12 along the frame rails 118. As shown in FIG. 5, the frame locking apertures 40 and the pin apertures 34 during the adjustment of the slide box 16 position may not be aligned, i.e., the locking pins 10 are not able to be in the locked position 142. To allow for the actuator 24 to move the locking pins 10 to the locked position 142, the frame locking apertures 40 and the pin apertures 34 must be substantially aligned. As shown in FIG. 6, the actuator 24 can move the locking pins 10 to the locked position 142 when the center points 120, 146 of each aperture 34, 40 are aligned along a substantially vertical axis 148. An upper portion 150 of the frame locking apertures 40 and an upper portion 152 of the pin apertures 34 may also be tangentially aligned when the center points 120, 146 are aligned along the substantially vertical axis 148.

Referring to FIGS. 7 and 8, the locking pins 10 are illustrated in the unlocked position 140. The first portion 30 and/or the second portion 36 of the pin end 28 may be partially received within the pin aperture 34. The first portion 30 and/or the second portion 36 of the pin end 28 are not received within the frame locking aperture 40.

Referring to FIGS. 9 and 10, the locking pins 10 are illustrated in the locked position 142. The first portion 30 of the pin end 28 may be partially received within and extend through the pin aperture 34. The second portion 36 of the pin end 28 is received within the frame locking aperture 40. When the locking pin 10 is in the locked position 142, the first center axis 52 is aligned with the center point 146 of pin aperture 34 of the slide box 16 and the second center axis 54 is aligned with the center point 120 of the frame locking aperture 40.

Referring to FIG. 4, the actuator 24 is configured to move the locking pins 10 may be a mechanical or electronic actuator to move the locking pins 10 between the unlocked position 140 and the locked position 142. As illustrated, the actuator 24 is a mechanical linkage. The actuator 24 may include a longitudinally-extending torsional bar 166 having a first end 168 pivotably received within the first support member 134a, and a second end 170 pivotably received within the second support member 134b. The torsional bar 166 is coupled to corresponding locking pins 10 via corresponding actuator arms 172 pivotably coupled to the torsional bar 166 via actuator cams 174. The actuator arms 172 are coupled to the second end 26 of the locking pins 10. The actuator arms 172 may be coupled to the locking pin 10 by extending through the aperture 102 defined by the locking pins 10. The actuator arm 172 may also be coupled to the locking pin 10 with a fastener, such as a pin, bolts, nuts, clips, or other similar fasteners extending through or securing the actuator arm 172 through the aperture 102 of the corresponding locking pins 10.

The torsional bar 166 is coupled to an actuator input arm 178 configured to rotate the torsional bar 166 via user input. The rotation of the torsional bar 166 by the actuator input arm 178 moves the locking pins 10 via the actuator arms 172 between the unlocked position 140 and the locked position 142. The actuator 24 is not limited to the illustrated configuration and may be an electronically controlled actuator (e.g., a motor) or other manually or user actuated actuator (e.g., a mechanical linkage).

Referring to FIGS. 4, 7 and 9, the locking arrangement 138 may also include a support bracket 180 or a plurality of support brackets 180 to support the locking pins 10. Each of the support brackets 180 generally supports a corresponding locking pin 10. The support brackets 180 each define an aperture to receive, guide, and support the locking pins 10. The support brackets 180 may align the locking pins 10 with the pin apertures 34 and allow for movement of the locking pin 10 between the locked and unlocked positions 140, 142. A center point of each the apertures of the support bracket 180 may align with the first center axis 52 and the center point 146 of the pin apertures 34. The aperture of the support bracket 180 may also be configured to engage the first and second truncated surfaces 96, 100 of the pin body 20 to prevent rotational movement of the locking pin 10 and align the second center axis 54 with the center point 120 of the frame locking apertures 40 when the center points 120, 146 of each aperture are vertically aligned.

The above description is considered that of the preferred embodiments only. Modifications of the embodiments disclosed herein will occur to those skilled in the art and to those who make or use the disclosed embodiments. Therefore, it is understood that the embodiments shown in the drawings and described above are merely for illustrative purposes and not intended to limit the scope of the invention, which is defined by the following claims as interpreted according to the principles of patent law, including the doctrine of equivalents.

1. A locking pin for a trailer having a trailer frame assembly and a slide box configured to be supported by a suspension arrangement and slidably displaceable along the trailer frame assembly, comprising:
a pin body having a first end configured to couple to an actuator and a second end; and
a pin end extending from the second end of the pin body, wherein the pin end includes a first portion having a substantially circular cross-section and configured to be received within a corresponding aperture in the slide box of the trailer and a second portion having a substantially circular cross-section configured to be selectively received within a corresponding aperture in the trailer frame assembly to prevent the slide box from sliding with reference to the trailer frame assembly, wherein the second portion is linearly offset from the first portion.

2. The locking pin of claim 1, wherein the second portion is vertically offset from the first portion when the pin end is received within the aperture of the trailer frame assembly.

3. The locking pin of claim 1, wherein the pin body includes a first truncated surface extending along a portion of a length of the pin body and a second truncated surface extending along the portion the length of the pin body, the second truncated surface opposing the first truncated surface.

4. The locking pin of claim 3, wherein the first end of the pin body defines an aperture extending between the first truncated surface and the second truncated surface, the aperture configured to couple to the actuator.

5. The locking pin of claim 3, wherein the slide box includes a support bracket having an aperture configured to engage the first truncated surface and second truncated surface to prevent the locking pin from rotating therein.

6. The locking pin of claim 1, wherein the substantially circular cross-section of the first portion has a first diameter, and the substantially circular cross-section of the second portion has a second diameter.

7. The locking pin of claim 6, wherein the first diameter is larger than the second diameter.

8. The locking pin of claim 6, wherein the second end of the pin body has a substantially circular cross-section having a third diameter, and wherein the third diameter is smaller than the first diameter.

9. The locking pin of claim 1, wherein a portion of a perimeter of the substantially circular cross-section of the first portion and a portion of a perimeter of the substantially circular cross-section of the second portion align to define a flush surface extending between the first portion and the second portion of the pin end.

10. The locking pin of claim 1, wherein the pin body and the first portion of the pin end extend along a first axis and the second portion of the pin end extends along a second axis.

11. The locking pin of claim 1, wherein the first end of the pin body defines an aperture extending between the first flat surface and the second flat surface, the aperture configured to couple to the actuator.

12. A locking pin for a slide box of a towed vehicle, the slide box configured to be supported by a suspension assembly and configured to be slidably displaced along a length of a vehicle frame assembly, comprising:
a pin body having a first end configured to couple to an actuator, a second end, and a first center axis extending along a length of the locking pin; and
a pin end extending from the second end of the pin body, wherein the pin end includes a substantially cylindrical first portion having a first diameter, and a substantially cylindrical second portion having a second diameter, wherein the first portion extends along the first center axis, and the second portion extends along a second center axis laterally offset from the first center axis, and wherein the second diameter is smaller than the first diameter, and wherein the second portion is configured to engage the vehicle frame assembly thereby preventing the sliding displacement of the slide box along the length of the vehicle frame assembly.

13. The locking pin of claim 12, wherein the second portion is vertically offset from the first portion when the second portion engages the vehicle frame assembly.

14. The locking pin of claim 12, wherein the substantially cylindrical first portion has a first perimeter and the substantially cylindrical second portion has a second perimeter, wherein a portion of the first perimeter aligns with a portion of the second perimeter defining a flush surface extending between the substantially cylindrical first portion and the substantially cylindrical second portion.

15. The locking pin of claim 12, wherein the pin body includes a first flat surface extending from the first end along a portion of the length of the pin body and a second flat surface extending from the first end along a portion of the length of the pin body, the second flat surface opposing the first flat surface, and wherein the pin body is substantially cylindrical extending from the first flat surface and the second flat surface to the second end.

16. The locking pin of claim 15, wherein the first end of the pin body defines an aperture extending between the first flat surface and the second flat surface, the aperture configured to couple to the actuator.

17. A slide box configured to be supported by a vehicle suspension arrangement and slidably displaceable along a vehicle trailer assembly, the slide box including the locking pin of claim 12.

18. A towed vehicle, comprising:
a vehicle frame assembly including a pair of frame rails each defining a plurality of pin apertures spaced along a length of each of the pair of frame rails, wherein each pin aperture of the plurality of pin apertures has a first diameter;
a slide box including a pair of slide rails configured to slide within the pair of frame rails, wherein one of the slide rails of the pair of slide rails defines a slide box aperture having a second diameter, and wherein the second diameter is larger than the first diameter;
an eccentric locking pin including a pin body and a pin end, the pin body having a first center axis extending along a length of the eccentric locking pin and including a proximal end and a distal end, the pin end coupled to the distal end of the pin body and including a first portion aligned with the first center axis, and a second portion aligned with a second center axis laterally offset from the first center axis; and
an actuator coupled to the proximal end of the pin body and configured to move the eccentric locking pin between an unlocked position allowing the slide box to slide along the frame rails and a locked position preventing the slide box from sliding along the frame rails, wherein the second portion of the pin end is received within a pin aperture of the plurality of pin apertures in the locked position, and wherein the first portion of the pin end is at least partially received within the slide box in the locked position and the unlocked position.

19. The towed vehicle of claim 18, wherein the second portion of the pin end is vertically offset from the first portion of the pin end when in the locked position.

20. The towed vehicle of claim 18, wherein the pin body includes a first flat surface extending along a portion of a length of the pin body and a second flat surface extending along the portion the length of the pin body, the second flat surface opposing the first flat surface, and wherein the slide box includes a support bracket having an aperture configured to engage the first flat surface and the second flat surface of the pin body to prevent the eccentric locking pin from rotating therein.

21. The towed vehicle of claim 20, wherein the first portion of the pin end is substantially cylindrical, and the second portion of the pin is substantially cylindrical.

22. The towed vehicle of claim 18, wherein the first portion of the pin end has a first perimeter, the second portion of the pin end has a second diameter, and wherein a portion of the first perimeter aligns with a portion of the second diameter defining a flush surface extending between the first portion and the second portion.
